(19) United States
(12) Patent Application Publication
(10) Pub. No.: US 2024/0149697 A1
(43) Pub. Date: May 9, 2024

(54) FUEL CELL VEHICLE AND METHOD OF CONTROLLING THE SAME

(71) Applicants: HYUNDAI MOTOR COMPANY, SEOUL (KR); KIA CORPORATION, SEOUL (KR)

(72) Inventors: Seong Cheol Jeong, Suwon-si (KR); Jae Ok Ha, Yongin-si (KR); Mi Ji Kim, Gwacheon-si (KR)

(21) Appl. No.: 18/219,367

(22) Filed: Jul. 7, 2023

(30) Foreign Application Priority Data
Nov. 8, 2022 (KR) 10-2022-0147829

(51) Int. Cl. B60L 7/18; B60L 50/75; H01M 8/04858; H01M 16/00

(52) U.S. Cl. CPC B60L 7/18; B60L 50/75; H01M 8/04947; H01M 16/006; B60L 2240/42; B60L 2240/54; B60L 2240/642; B60L 2250/26; B60L 2250/28; H01M 2220/20; H01M 2250/20

(57) ABSTRACT

A fuel cell vehicle includes a fuel cell stack and a battery, a drive motor configured to drive the vehicle through electrical energy of the fuel cell stack or the battery and to generate electric power through regenerative braking during braking, and a controller configured to set a limit of a regenerative braking output of a drive motor upon braking of the vehicle, taking into consideration a driving environment factor in an exterior of the vehicle, a vehicle manipulation factor of a vehicle driver, and a vehicle driving factor as to a driving state of a vehicle part including the fuel cell stack and the battery.

### CROSS REFERENCE TO RELATED APPLICATIONS

This application claims the benefit of Korean Patent Application No. 10-2022-0147829, filed on Nov. 8, 2022, in the Korean Intellectual Property Office, the disclosure of which is incorporated herein by reference.

### BACKGROUND

### 1. Field

The present disclosure relates to a fuel cell vehicle and a method of controlling the same, and more particularly to a technology for variably calculating a limit of a regenerative braking output in accordance with various driving situations of a fuel cell vehicle, thereby preventing generation of overvoltage at a main bus terminal of the fuel cell vehicle.

### 2. Description of the Related Art

A fuel cell is a device for producing electrical energy through electrochemical reaction generated in an interior of a fuel cell stack thereof using hydrogen and air received from an exterior thereof. Such a fuel cell may be used as a power source in various fields associated with a fuel cell electric vehicle (FCEV), a fuel cell for electric power generation, or the like.

A fuel cell system includes a fuel cell stack in which a plurality of fuel cells used as a power source are stacked, a fuel supply system configured to supply hydrogen, etc. as a fuel to the fuel cell stack, an air supply system configured to supply oxygen as an oxidant required for electrochemical reaction, a water and heat management system configured to control a temperature of the fuel cell stack, etc.

The fuel supply system supplies, to an anode (a fuel electrode) of the fuel cell stack, hydrogen contained in a compressed state in a hydrogen tank after reducing the pressure of the compressed hydrogen. The air supply system sucks in ambient air through operation of an air compressor, and supplies the sucked air to a cathode (an air electrode) of the fuel cell stack.

When hydrogen is supplied to the fuel electrode of the fuel cell stack, and oxygen is supplied to the air electrode of the fuel cell stack, hydrogen ions are separated from the fuel electrode through catalyst reaction. The separated hydrogen ions are transferred to the air electrode, that is, an oxidation electrode, through an electrolyte membrane. The hydrogen ions separated from the fuel electrode generate electrochemical reaction at the oxidation electrode together with electrons and oxygen and, as such, electrical energy may be obtained. In detail, electrochemical oxidation of hydrogen is generated at the fuel electrode, and electrochemical reduction of oxygen is generated at the air electrode. In accordance with migration of electrons produced during such reactions, electricity and heat are generated. In addition, water vapor or water is produced in accordance with chemistry of bonding hydrogen and oxygen.

An exhaust device is provided in order to exhaust byproducts such as water vapor, water, and heat generated in an electrical energy production procedure of the fuel cell stack and hydrogen, oxygen, etc. unreacted in the electrical energy production procedure. Accordingly, gases such as water vapor, hydrogen and oxygen are exhausted into the atmosphere through an exhaust passage.

Electrochemical reaction carried out within a fuel cell may be expressed by the following reaction formula.

2H₂(g)→4H⁺(aq.)+4e⁻ [Reaction at Anode]

O₂(g)+→H⁺(aq.)+4e⁻→2H₂O(l) [Reaction at Cathode]

2H₂(g)+O₂(g)→2H₂O(l)+Electrical Energy+Thermal Energy [Overall Reaction]

As expressed by the reaction formula, four hydrogen ions and four electrons are produced through decomposition of a hydrogen molecule. As the electrons migrate through an external circuit, current (electrical energy) is generated. The hydrogen ions migrate to a cathode through an electrolyte membrane, and undergo reduction electrode reaction at the cathode. As byproducts of the electrochemical reaction, water and heat are produced.

Meanwhile, a fuel cell vehicle is constituted by an electric storage means such as a battery and a fuel cell stack and, as such, provides an output for a load within the fuel cell vehicle. Regenerative braking is performed during braking of the fuel cell vehicle in order to enhance the efficiency of the fuel cell vehicle. Electric power generated through the regenerative braking is stored in the battery. When regenerative braking energy greater than an allowable amount is introduced into the battery, overvoltage is generated at a main bus terminal. In this case, damage/breakage/fire may occur at parts of the fuel cell vehicle.

Therefore, a scheme for maximally increasing an amount of electric power generated through regenerative braking while securing stability of regenerative braking in order to enhance the efficiency of a fuel cell vehicle is needed.

The above matters disclosed in this section are merely for enhancement of understanding of the general background of the disclosure and should not be taken as an acknowledgement or any form of suggestion that the matters form the related art already known to a person skilled in the art.

### SUMMARY

Therefore, the present disclosure has been made in view of the above problems, and it is an object of the present disclosure to provide a fuel cell vehicle and a method of controlling the same, which are capable of not only securing stability of regenerative braking, thereby maximizing an amount of electric power generated through the regenerative braking, but also preventing overvoltage from being applied to a main bus terminal during the regenerative braking, thereby enhancing fuel cell vehicle durability.

In accordance with an aspect of the present disclosure, the above and other objects can be accomplished by the provision of a fuel cell vehicle including a fuel cell stack and a battery, a drive motor configured to drive the vehicle through electrical energy of the fuel cell stack or the battery and to generate electric power through regenerative braking during braking, and a controller configured to set a limit of a regenerative braking output of a drive motor upon braking of the vehicle, taking into consideration a driving environment factor in an exterior of the vehicle, a vehicle manipulation factor of a vehicle driver, and a vehicle driving factor as to a driving state of a vehicle part comprising the fuel cell stack and the battery.

The vehicle environment factor may include an inclination of a road, and the controller may reduce the regenerative braking output limit of the drive motor as a downhill inclination of the road increases.

The vehicle manipulation factor may include a depth variation of a brake pedal or a depth variation of an accelerator pedal, and the controller may reduce the regenerative braking output limit of the drive motor as the depth variation of the brake pedal or the depth variation of the accelerator pedal increases.

The vehicle driving factor may include an output consumption amount of a fuel cell balance of plant (BoP), and the controller may reduce the regenerative braking output limit of the drive motor as the output consumption amount of the fuel cell BoP increases.

The controller may calculate a reference regenerative braking output limit according to a state of charge (SOC) of the battery, and may set the regenerative braking output limit of the drive motor by reflecting the driving environment factor, the vehicle manipulation factor, and the vehicle driving factor in the reference regenerative braking output limit through an expression as follows:

Z=X−d₁*D+(a₁*A₁+a₂*A₂+a₃*A₃)
Z: regenerative braking output limit
X: reference regenerative braking output limit
D: amount of electric power generated through fuel cell stack
A₁: driving environment factor
A₂: vehicle manipulation factor
A₃: vehicle driving factor
a₁, a₂, a₃, and d₁: constants.

The controller may control the regenerative braking output of the drive motor in accordance with the set regenerative braking output limit upon beginning of regenerative braking, and may again set the regenerative braking output limit based on a difference between the regenerative braking output limit and a regenerative output of the drive motor after beginning of regenerative braking.

The re-set regenerative braking output limit may be increased in proportion to the difference between the regenerative braking output limit and the regenerative output of the drive motor.

The regenerative braking output limit may be maintained when the difference between the regenerative braking output limit and the regenerative output of the drive motor is not greater than a first value.

The re-set regenerative braking output limit may be increased in proportion to the difference between the regenerative braking output limit and the regenerative output of the drive motor when the difference between the regenerative braking output limit and the regenerative output of the drive motor is greater than the first value.

The re-set regenerative braking output limit may be maintained irrespective of the difference between the regenerative braking output limit and the regenerative output of the drive motor when the difference between the regenerative braking output limit and the regenerative output of the drive motor is greater than a second value.

The second value may be greater than the first value.

The controller may determine a regenerative braking output limit of the drive motor after beginning of regenerative braking by selecting a smaller one of a reference regenerative braking output limit, a comparative value calculated based on an amount of electric power generated in the fuel cell stack after beginning of regenerative braking, and a regenerative braking output limit again set after beginning of regenerative braking.

The comparative value may be calculated through an expression as follows:

Y=X−d₂*E
Y: comparative value
X: reference regenerative braking output limit
E: amount of electric power generated in fuel cell stack after beginning of regenerative braking
d₂: constant

In accordance with another aspect of the present disclosure, there is provided a method of controlling the fuel cell vehicle, the method including calculating, by the controller, a driving environment factor in an exterior of the vehicle, a vehicle manipulation factor of a vehicle driver, and a vehicle driving factor as to a driving state of a vehicle part including the fuel cell stack and the battery, and setting, by the controller, a limit of a regenerative braking output of the drive motor upon braking of the vehicle, taking into consideration the calculated driving environment factor, the calculated vehicle manipulation factor and the calculated vehicle driving factor.

Setting the limit of the regenerative braking output may include calculating a reference regenerative braking out limit according to a state of charge (SOC) of the battery, calculating, by the controller, an amount of electric power generated in the fuel cell stack, calculating, by the controller, an offset based on the driving environment factor, the vehicle manipulation factor and the vehicle driving factor, and setting the regenerative braking output limit by performing an arithmetic operation based on the calculated reference regenerative braking output limit, the calculated amount of electric power generated in the fuel cell stack, and the calculated offset.

### BRIEF DESCRIPTION OF THE FIGURES

The above and other objects, features and other advantages of the present disclosure will be more clearly understood from the following detailed description taken in conjunction with the accompanying drawings, in which:

FIG. 1 is a schematic view of a fuel cell vehicle according to an exemplary embodiment of the present disclosure;

FIG. 2 is a graph of a re-set regenerative braking output limit; and

FIGS. 3 and 4 are flowcharts of a method for controlling a fuel cell system in accordance with an exemplary embodiment of the present disclosure.

### DETAILED DESCRIPTION

Hereinafter, preferred embodiments of the present disclosure will be described in detail with reference to the accompanying drawings, and the same or similar elements are designated by the same reference numerals regardless of the numerals in the drawings and redundant description thereof will be omitted.

In describing the present disclosure, moreover, the detailed description will be omitted when a specific description of publicly known technologies to which the disclosure pertains is judged to obscure the gist of the present disclosure. In addition, it should be noted that the accompanying drawings are merely illustrated to easily explain the spirit of the disclosure, and therefore, should not be construed as limiting the spirit of the disclosure to the accompanying drawings. On the contrary, the disclosure is to cover all modifications, equivalents, and alternatives falling within the spirit and scope of the disclosure as defined by the claims.

In the meantime, although terms including an ordinal number, such as first or second, may be used to describe a variety of constituent elements, the constituent elements are not limited to the terms, and the terms are used only for the purpose of discriminating one constituent element from other constituent elements.

As used in the description of the disclosure and the appended claims, the singular forms are intended to include the plural forms as well, unless context clearly indicates otherwise.

It will be further understood that the terms “comprises” and/or “comprising,” or “includes” and/or “including” when used in this specification, specify the presence of stated features, regions, integers, steps, operations, elements, and/or combinations thereof, but do not preclude the presence or addition of one or more other features, regions, integers, steps, operations, elements, components, and/or combinations thereof.

Meanwhile, conventionally, in order to control an amount of electric power generated through regenerative braking in a fuel cell vehicle not to be greater than a charging capacity acceptable by a battery, a limit of a regenerative braking output is calculated, and the amount of electric power generated through regenerative braking is controlled based on the calculated regenerative braking output limit.

However, such a method cannot reflect various driving situations because a fixed regenerative braking output limit is calculated through tests. Therefore, technology for varying a regenerative braking output limit through factors required for calculation of the regenerative braking output limit in accordance with various driving situations, thereby maximizing an amount of electric power generated through regenerative braking while maintaining stability of regenerative braking, is needed.

A fuel cell vehicle according to an exemplary embodiment of the present disclosure for accomplishing the above-described object includes a fuel cell stack 200, a battery 100, a drive motor 300 configured to drive the vehicle through electrical energy of the fuel cell stack 200 or the battery 100 and to generate electric power through regenerative braking during braking, and a controller 400 configured to set a limit of a regenerative braking output of the drive motor 300 upon braking of the vehicle, taking into consideration a driving environment factor in an exterior of the vehicle, a vehicle manipulation factor of a vehicle driver, and a vehicle driving factor as to a driving state of a vehicle part including the fuel cell stack 200 and the battery 100.

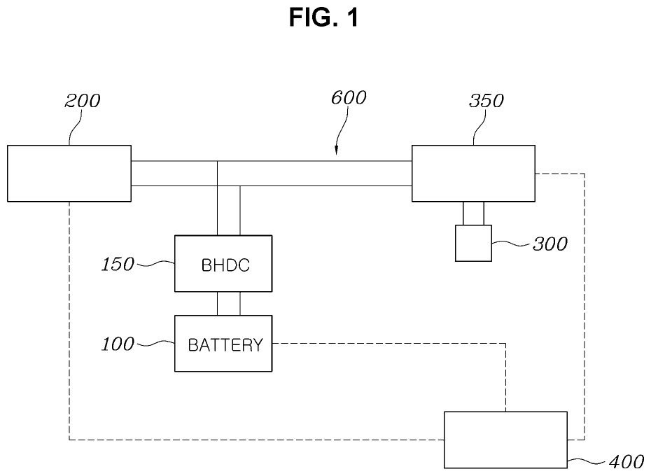

In detail, FIG. 1 shows a schematic view of the fuel cell vehicle according to the exemplary embodiment of the present disclosure. Referring to FIG. 1, the fuel cell stack 200, the battery 100, the drive motor 300, etc. are electrically interconnected through a main bus terminal 600.

A bidirectional high-voltage DC-DC converter (BHDC) 150 is provided at the main bus terminal 600 in front of the battery 100. The BHDC 150 may reduce voltages of electric power produced in the fuel cell stack 200 and electric power generated through regenerative braking, and may recharge the battery 100 with the voltage-reduced electric power.

The drive motor 300 may be connected to a motor control unit (MCU) 350 and, as such, may be controlled through the motor control unit 350. Meanwhile, the term “unit” or “control unit” used in a specific term such as a motor control unit (MCU) or the like is only a term widely used for designation of a controller for controlling a particular function of a vehicle and, as such, does not mean a generic functional unit.

Meanwhile, the controller 400 may be a configuration communicating with and controlling the motor controller 350, the fuel cell stack 200, the battery 100, etc. The controller 400 may include a communication device configured to communicate with another controller or a sensor, for control of a function to be performed thereby, a memory configured to store an operating system, logic commands, input/output information, etc., and at least one processor configured to execute discrimination, calculation, determination, etc. required for control of the function to be performed.

The controller 400 sets a limit of a regenerative braking output of the drive motor 300 upon braking of the vehicle, taking into consideration a driving environment factor in an exterior of the vehicle, a vehicle manipulation factor of a vehicle driver, and a vehicle driving factor as to a driving state of a vehicle part including the fuel cell stack 200 and the battery 100.

In conventional cases, it is not possible to reflect various driving situations because a limit of a regenerative braking output is set by a fixed constant calculated through tests. In the fuel cell vehicle according to the exemplary embodiment of the present disclosure, however, it may be possible to variably set a limit of a regenerative braking output, taking into consideration a driving environment factor in an exterior of the vehicle, a vehicle manipulation factor of a vehicle driver, and a vehicle driving factor as to a driving state of a vehicle part including the fuel cell stack 200 and the battery 100.

Meanwhile, a certain time is taken to stop generation of electric power in the fuel cell stack 200 upon braking of the fuel cell vehicle. For this reason, a regenerative braking output is generated in a maximum amount when the fuel cell vehicle begins regenerative braking. To this end, when the fuel cell vehicle begins regenerative braking, it is necessary to set a limit of the regenerative braking output, taking into consideration the current driving situation of the vehicle, in order to prevent occurrence of a situation in which a high voltage is applied to the main bus terminal 600.

In detail, factors to be taken into consideration are a driving environment factor, a vehicle manipulation factor, and a vehicle driving factor.

The driving environment factor is a factor as to a driving environment in an exterior of the vehicle. For example, the driving environment factor may be an inclination of a road. The controller 400 may reduce a limit of the regenerative braking output of the drive motor 300 when a downhill inclination of the road increases.

When the downhill inclination of the road increases, an amount of regenerative braking of the drive motor 300 may be increased. In this case, there is a high possibility of application of overvoltage to the main bus terminal 600. To this end, the controller 400 reduces the regenerative braking output limit of the drive motor 300 when a downhill inclination of the road increases.

Meanwhile, the vehicle manipulation factor is a factor according to vehicle manipulation of the driver in an interior of the vehicle. For example, the vehicle manipulation factor may be a depth variation of a brake pedal or a depth variation of an accelerator pedal.

That is, the controller 400 may recognize an increase in depth variation of the brake pedal as a sudden braking situation. In this situation, the regenerative braking amount of the drive motor 300 may be increased and, as such, there is a high possibility that overvoltage is applied to the main bus terminal 600.

To this end, the controller 400 may reduce the regenerative braking output limit of the drive motor 300 when the depth variation of the brake pedal increases.

In addition, the controller 400 may recognize an increase in depth variation of the accelerator pedal as a situation in which engine braking by the vehicle driver is required. In this situation, the regenerative braking amount of the drive motor 300 may be increased. To this end, the controller 400 may reduce the regenerative braking output limit of the drive motor 300 when the depth variation of the brake pedal increases.

Measurement of a depth variation of the brake pedal and measurement of a depth variation of the accelerator pedal are preferably performed in opposite directions, respectively, because the brake pedal and the accelerator pedal perform different functions, respectively. That is, it should be understood that the depth variation of the brake pedal is increased when depression of the brake pedal increases, and the depth variation of the accelerator pedal is increased when depression of the accelerator pedal decreases.

Meanwhile, the vehicle driving factor is a factor as to a driving state of a vehicle part including the fuel cell stack 200 and the battery 100. For example, the vehicle driving factor may be an output consumption amount of a fuel cell balance of plant (BoP).

That is, when the output consumption amount of the fuel cell BoP increases, the amount of electric power generated in the fuel cell stack is proportionally increased. Accordingly, when the output consumption amount of the fuel cell BoP increases, the time taken to reduce the output of the fuel cell stack 200 is increased.

Accordingly, when the output consumption amount of the fuel cell BoP increases, the regenerative braking output limit of the drive motor 300 may be reduced.

Meanwhile, the controller 400 may calculate a reference regenerative braking output limit according to a state of charge (SOC) of the battery 100, and may set a regenerative braking output limit of the drive motor 300 by reflecting a driving environment factor, a vehicle manipulation factor, and a vehicle driving factor in the reference regenerative braking output limit through the following Expression 1:

Z=X−d₁*D+(a₁*A₁+a₂*A₂+a₃*A₃)
Z: regenerative braking output limit
X: reference regenerative braking output limit
D: amount of electric power generated through fuel cell stack
A₁: driving environment factor
A₂: vehicle manipulation factor
A₃: vehicle driving factor
a₁, a₂, a₃, and d₁: constants.

In detail, the reference regenerative braking output limit is a reference value required for setting of a regenerative braking output limit of the drive motor 300. That is, the reference regenerative braking output limit is a value that can be determined in accordance with an SOC of the battery or a recharge capacity of the battery 100.

In this case, the regenerative braking output limit is obtained by performing an arithmetic operation based on a value obtained by reflecting the amount of electric power generated in the fuel cell stack 200, the driving environment factor, the vehicle manipulation factor, and the vehicle driving factor in the reference regenerative braking output limit.

The regenerative braking output limit may be a value obtained by deducting the amount of electric power generated in the fuel cell stack 200 from the reference regenerative braking output limit. However, it may be possible to further reduce the regenerative braking output limit by calculating an offset according to a detailed driving environment of the vehicle, detailed manipulation of the user, a detailed state of an internal part of the vehicle, etc.

That is, overvoltage may be applied to the main bus terminal 600 when no offset is applied. Accordingly, the regenerative braking output limit may be set through application of an offset.

In this case, d₁ may typically have a value of 1. When d₁ is selected to have a value greater than 1, a value greater than the amount of electric power generated in the fuel cell stack 200 is applied and, as such, there may be a possibility that a reduction in regenerative braking recovery rate occurs, but there is an advantage in terms of stability.

When d₁ is selected to have a value smaller than 1, a value smaller than the amount of electric power generated in the fuel cell stack 200 is applied and, as such, there may be an advantage in terms of regenerative braking recovery rate, but there is a disadvantage in terms of stability.

Although d₁ may be varied to be greater or smaller than 1 in accordance with a situation, it is preferred that d₁ have a value of 1.

Meanwhile, the regenerative braking output of the fuel cell vehicle has a maximum value when the fuel cell vehicle begins regenerative braking. This is because a certain time is taken to stop generation of electric power in the fuel cell stack 200.

That is, when the fuel cell vehicle begins regenerative braking, it is necessary to set the regenerative braking output limit to be small because the regenerative braking output is maximum. However, after the fuel cell vehicle begins regenerative braking, the amount of electric power generated in the fuel cell stack 200 is gradually reduced. Accordingly, it is necessary to again set the regenerative braking output limit.

In other words, although the controller 400 controls the regenerative braking output of the drive motor 300 in accordance with the set regenerative braking output limit upon beginning of regenerative braking, the controller 400 again sets the regenerative braking output limit based on a difference between the regenerative braking output limit and a regenerative output of the drive motor after beginning of regenerative braking and, as such, it may be possible to enhance a regenerative braking output recovery rate.

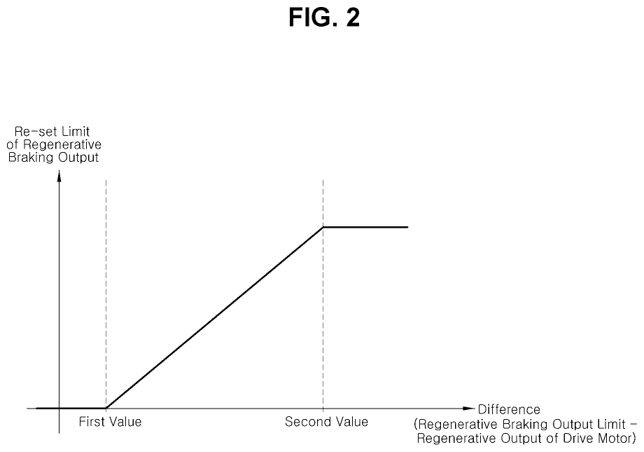

FIG. 2 is a graph of a re-set regenerative braking output limit. Re-setting of the regenerative braking output limit will be described with reference to FIG. 2.

The re-set regenerative braking output limit may be increased in proportion to a difference between the regenerative braking output limit and the regenerative output of the drive motor 300.

In detail, when the regenerative braking output limit and the regenerative output of the drive motor 300 are equal and, as such, the difference therebetween is 0, this is a situation in which the regenerative braking output limit should be continuously maintained. However, when the difference between the regenerative braking output limit and an actual regenerative output of the drive motor 300 is positive, this is a situation in which an increase in the regenerative braking output limit is allowable.

Accordingly, it is preferred that, when the difference between the regenerative braking output limit and the regenerative output of the drive motor 300 increases, the re-set regenerative braking output limit also be proportionally increased.

Of course, in some cases, it may also be preferred that, when the difference between the regenerative braking output limit and the regenerative output of the drive motor 300 is not greater than a first value, the regenerative braking output limit be maintained.

In detail, when the difference between the regenerative braking output limit and the actual regenerative output of the drive motor 300 is negative, this is a situation in which the regenerative braking output generated from the drive motor 300 is greater than the regenerative braking output limit. In this case, accordingly, it is preferred that the regenerative braking output limit be maintained.

However, even though the difference between the regenerative braking output limit and the regenerative output of the drive motor 300 is a positive value greater than 0, there may be a possibility that overvoltage is applied to the main bus terminal 600 when the regenerative braking output limit is re-set to an increased value.

Therefore, it is preferred that, for stability of the fuel cell vehicle, the first value be set to be greater than 0, and the regenerative braking output limit be maintained to be equal to a previous value thereof when the difference between the regenerative braking output limit and the regenerative output of the drive motor 300 is not greater than the first value.

In addition, it is preferred that, when the difference between the regenerative braking output limit and the regenerative output of the drive motor 300 is greater than the first value, the re-set regenerative braking output limit be increased in proportion to the difference between the regenerative braking output limit and the regenerative output of the drive motor 300.

In detail, an increase rate of the re-set regenerative braking output limit may be set such that the regenerative braking output limit has a predetermined increase rate. Of course, when the limit is rapidly increased due to an excessively high increase rate, there may be a possibility of degradation in stability even though there is an advantage in terms of a regenerative braking output recovery rate. Therefore, it is preferred that an appropriate increase rate be set.

On the other hand, when the difference between the regenerative braking output limit and the regenerative output of the drive motor 300 is greater than a second value, the re-set regenerative braking output limit may be maintained irrespective of the difference between the regenerative braking output limit and the regenerative output of the drive motor 300.

In this case, the second value is greater than the first value.

Meanwhile, the controller 400 may determine a regenerative braking output limit of the drive motor 300 after beginning of regenerative braking by selecting a smaller one of a reference regenerative braking output limit, a comparative value calculated based on an amount of electric power generated in the fuel cell stack 200 after beginning of regenerative braking, and a regenerative braking output limit again set after beginning of regenerative braking.

In detail, after beginning of regenerative braking, a value obtained by deducting the amount of electric power generated in the fuel cell stack 200 after beginning of regenerative braking from the reference regenerative braking output limit based on the SOC of the battery 100 may be set as a regenerative braking output limit.

Of course, overvoltage may be applied even after beginning of regenerative braking, in accordance with driving situations. Therefore, it is preferred that a smaller one of the reference value and the re-set regenerative braking output limit be determined as a regenerative braking output limit.

In detail, the comparative value may be calculated through the following Expression 2:

Y=X−d₂*E
Y: comparative value
X: reference regenerative braking output limit
E: amount of electric power generated in fuel cell stack after beginning of regenerative braking
d₂: constant

In Expression 2, d₂ is constant, and typically has a value of 1. When a value greater than 1 is selected as d₂, there may be a possibility of degradation in regenerative braking recovery rate, but there may be an advantage in terms of stability, because a value greater than the amount of electric power generated in the fuel cell stack 200 is applied.

When a value smaller than 1 is selected as d₂, there may be an advantage in terms of regenerative braking recovery rate, but there may be a disadvantage in terms of stability, because a value smaller than the amount of electric power generated in the fuel cell stack 200 is applied.

Although the value of d₂ may be varied to be greater or smaller than 1 in accordance with situations, it is preferred that d₂ have a value of 1.

In addition, d₂ is a constant set independently of d₁.

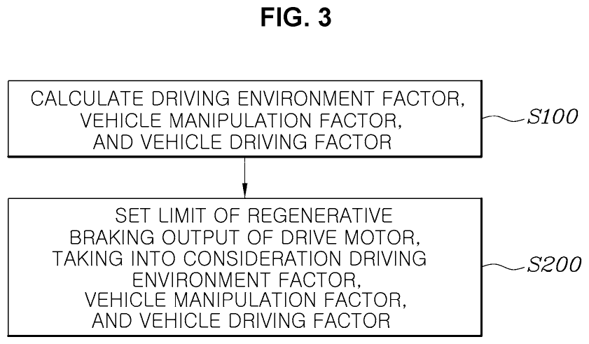

Meanwhile, referring to FIG. 3, which shows a method of controlling the fuel cell vehicle in accordance with an exemplary embodiment of the present disclosure, the method includes calculating, by the controller 400, a driving environment factor in an exterior of the vehicle, a vehicle manipulation factor of a vehicle driver, and a vehicle driving factor as to a driving state of a vehicle part including the fuel cell stack 200 and the battery 100 at S100, and setting, by the controller 400, a limit of a regenerative braking output of the drive motor 300 upon braking of the vehicle, taking into consideration the calculated driving environment factor, the calculated vehicle manipulation factor and the calculated vehicle driving factor at S200.

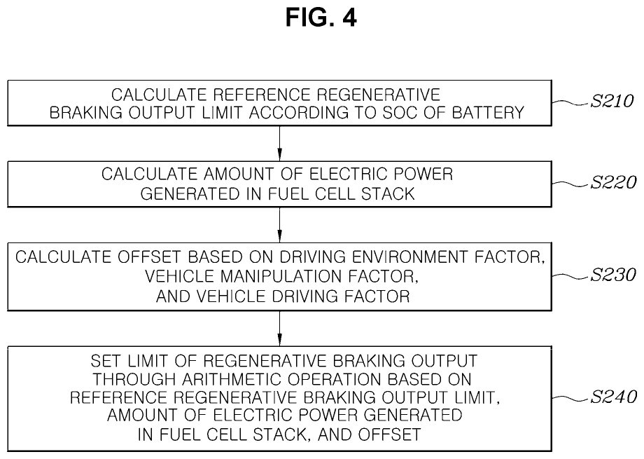

Referring to FIG. 4, the setting of the limit of the regenerative braking output (S200) may include calculating a reference regenerative braking output limit according to a state of charge (SOC) of the battery 100 at S210, calculating, by the controller 400, an amount of electric power generated in the fuel cell stack 200 at S220, calculating, by the controller 400, an offset based on the driving environment factor, the vehicle manipulation factor and the vehicle driving factor at S230, and setting the regenerative braking output limit by performing an arithmetic operation based on the calculated reference regenerative braking output limit, the calculated amount of electric power generated in the fuel cell stack 200, and the calculated offset at S240.

As apparent from the above description, in accordance with the fuel cell vehicle and the fuel cell vehicle control method according to the exemplary embodiments of the present disclosure, stability of regenerative braking may be secured. Accordingly, an amount of electric power generated through regenerative braking may be maximized. In addition, it may be possible to prevent application of overvoltage to a main bus terminal during regenerative braking and, as such, to achieve an enhancement in durability of the fuel cell vehicle.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

1. A fuel cell vehicle comprising:
a fuel cell stack and a battery;
a drive motor configured to drive the vehicle through electrical energy of the fuel cell stack or the battery, and to generate electric power through regenerative braking during braking; and
a controller configured to set a limit of a regenerative braking output of a drive motor upon braking of the vehicle, wherein the controller sets the limit of regenerative braking output based on a driving environment factor in an exterior of the vehicle, a vehicle manipulation factor of a vehicle driver, and a vehicle driving factor as to a driving state of a vehicle part comprising the fuel cell stack and the battery.

2. The fuel cell vehicle according to claim 1, wherein the vehicle environment factor comprises an inclination of a road, and the controller reduces the regenerative braking output limit of the drive motor as a downhill inclination of the road increases.

3. The fuel cell vehicle according to claim 1, wherein the vehicle manipulation factor comprises a depth variation of a brake pedal or a depth variation of an accelerator pedal, and the controller reduces the regenerative braking output limit of the drive motor as the depth variation of the brake pedal or the depth variation of the accelerator pedal increases.

4. The fuel cell vehicle according to claim 1, wherein the vehicle driving factor comprises an output consumption amount of a fuel cell balance of plant (BoP), and the controller reduces the regenerative braking output limit of the drive motor as the output consumption amount of the fuel cell BoP increases.

5. The fuel cell vehicle according to claim 1, wherein the controller calculates a reference regenerative braking output limit according to a state of charge (SOC) of the battery, and sets the regenerative braking output limit of the drive motor by reflecting the driving environment factor, the vehicle manipulation factor, and the vehicle driving factor in the reference regenerative braking output limit through an expression as follows:
Z=X−d₁*D+(a₁*A₁+a₂*A₂+a₃*A₃), where
Z is a regenerative braking output limit;
X is a reference regenerative braking output limit;
D is an amount of electric power generated through the fuel cell stack;
A₁ is a driving environment factor;
A₂ is a vehicle manipulation factor;
A₃ is a vehicle driving factor; and
a₁, a₂, a₃, and d₁ are constants.

6. The fuel cell vehicle according to claim 1, wherein the controller controls the regenerative braking output of the drive motor in accordance with the set regenerative braking output limit upon beginning of regenerative braking, and again sets the regenerative braking output limit based on a difference between the regenerative braking output limit and a regenerative output of the drive motor after beginning of regenerative braking.

7. The fuel cell vehicle according to claim 6, wherein the re-set regenerative braking output limit is increased in proportion to the difference between the regenerative braking output limit and the regenerative output of the drive motor.

8. The fuel cell vehicle according to claim 6, wherein the regenerative braking output limit is maintained when the difference between the regenerative braking output limit and the regenerative output of the drive motor is not greater than a first value.

9. The fuel cell vehicle according to claim 8, wherein the re-set regenerative braking output limit is increased in proportion to the difference between the regenerative braking output limit and the regenerative output of the drive motor when the difference between the regenerative braking output limit and the regenerative output of the drive motor is greater than the first value.

10. The fuel cell vehicle according to claim 9, wherein the re-set regenerative braking output limit is maintained irrespective of the difference between the regenerative braking output limit and the regenerative output of the drive motor when the difference between the regenerative braking output limit and the regenerative output of the drive motor is greater than a second value.

11. The fuel cell vehicle according to claim 10, wherein the second value is greater than the first value.

12. The fuel cell vehicle according to claim 6, wherein the controller determines a regenerative braking output limit of the drive motor after beginning of regenerative braking by selecting a smaller one of a reference regenerative braking output limit, a comparative value calculated based on an amount of electric power generated in the fuel cell stack after beginning of regenerative braking, and a regenerative braking output limit again set after beginning of regenerative braking.

13. The fuel cell vehicle according to claim 12, wherein the comparative value is calculated through an expression as follows:
Y=X−d₂*E, where
Y is a comparative value;
X is a reference regenerative braking output limit;
E is an amount of electric power generated in fuel cell stack after beginning of regenerative braking; and
d₂ is constant.

14. A method of controlling the fuel cell vehicle of claim 1, the method comprising:
calculating, by the controller, a driving environment factor in an exterior of the vehicle, a vehicle manipulation factor of a vehicle driver, and a vehicle driving factor as to a driving state of a vehicle part comprising the fuel cell stack and the battery; and
setting, by the controller, a limit of a regenerative braking output of the drive motor upon braking of the vehicle, based on the calculated driving environment factor, the calculated vehicle manipulation factor, and the calculated vehicle driving factor.

15. The method according to claim 14, wherein setting the limit of the regenerative braking output comprises:
calculating a reference regenerative braking out limit according to a state of charge (SOC) of the battery;
calculating, by the controller, an amount of electric power generated in the fuel cell stack;
calculating, by the controller, an offset based on the driving environment factor, the vehicle manipulation factor and the vehicle driving factor; and
setting the regenerative braking output limit by performing an arithmetic operation based on the calculated reference regenerative braking output limit, the calculated amount of electric power generated in the fuel cell stack, and the calculated offset.
